(19) United States
(12) Patent Application Publication
(10) Pub. No.: US 2006/0282771 A1
(43) Pub. Date: Dec. 14, 2006

(54) Verifying document compliance to a subsidiary standard

(76) Inventor: Tad Vinci, Plaistow, NH (US)

Correspondence Address: PROSKAUER ROSE LLP, ONE INTERNATIONAL PLACE 14TH FL, BOSTON, MA, 02110, US

(21) Appl. No.: 11/149,829

(22) Filed: Jun. 10, 2005

(51) Int. Cl. G06F 17/00

(52) U.S. Cl. 715/530

(57) ABSTRACT

Described are methods, systems, and apparatus, including computer program products, for verifying document and/or web page compliance to a subsidiary standard. A set of rules representing one or more aspects of the subsidiary standard are obtained. It is determined, using a first rule from the set of rules, if an element of the document is compliant with the subsidiary standard. A display of the document is generated in a browser application. If the element is compliant with the subsidiary standard, the element is displayed normally. If the element is not compliant, the element is displayed with a visual indicator.

### FIELD OF THE INVENTION

The present invention relates to computer-based methods and apparatuses, including computer program products, for verifying document compliance to a subsidiary standard.

### BACKGROUND

To make web content available to an even wider audience, particularly those with some form of physical disability such as blindness, several organizations have issued guidelines and/or requirements to make web pages more accessible. For example, in the United States of America (“US”) Section 508 requires that all web sites dealing with the US Federal Government must be accessible to people with disabilities. Other governments have issued similar requirements, such as the United Kingdom (“UK”) Disability Discrimination Act, the Canadian Common Look and Feel, the eEurope Plan, etc. Similarly, the World Wide Web Consortium (“W3C”) has issued Web Content Accessibility Guidelines (“WCAG”) to serve as a standard for achieving accessibility (see e.g. the W3C web accessibility initiatives at http://www.w3.org/WAI/).

To verify compliance with any of these requirements/guidelines, a “compliance tester,” i.e., a person responsible for the site's compliance, can read a web page's source code and try to find errors based on that manual review. Alternatively, a compliance tester can use an assistive browser that a disabled user would use, such as JAWS, to read the page out loud and try to determine whether the assistive browser encounters any content parsing issues or misreads an important aspect of the document. A compliance tester can also use tools such as WebXACT and Bobby™ (see e.g., http://webxact.watchfire.com/ and http://www.watchfire.com/products/desktop/bobby/default.aspx, both of which are administered by Watchfire Corporation of Waltham Mass.) to generate a report listing the different errors that were found. For each error, the report typically lists the line number of a web page's source code at which the error was found, along with a reproduction of the source code at that line number. For example, the following is a sample of a portion of the output generated using Bobby™ v. 4.01:

This page does not meet the requirements for US 508 Approved status. Below is a list of 1 Section 508 accessibility error(s) found:

Provide alternative text for all images. (4 instances)

Line 242:<td bgcolor=“#cccccc” height=“1”><img
src=“https://www.fidelity.com/images/clear.gif” width=“1”
height=“1”></td>
Line 308:<td bgcolor=“#cccccc” height =“1”><img
src=“https://www.fidelity.com/images/clear.gif” width=“1”
height=“1”></td>
Line 585:<td bgcolor=“#666666” height=“1”><img
src=“https://www.fidelity.com/images/clear.gif”
width=“1”></td>
Line 597:<td bgcolor=”#666666” height=“1”><img
src=“https://www.fidelity.com/images/clear.gif”
width=“1”></td>

As shown, Bobby™ lists the non-compliant lines of code, requiring the compliance tester to be able to recognize how the particular line is not compliant.

In any of these scenarios, if the compliance tester is not the same individual that is developing the web site (herein “site developer”), additional communications may be necessary between the two to effect changes in the web site to make the site compliant.

### SUMMARY OF THE INVENTION

The techniques described herein feature an automated tool that includes computer-based methods and apparatuses, including computer program products, for verifying document compliance to a subsidiary standard. In one aspect, a computerized method for verifying document compliance to a subsidiary standard is provided. The method includes obtaining a set of rules representing one or more requirements of the subsidiary standard; determining, using a first rule from the set of rules, if an element of the document is compliant with the subsidiary standard; and generating a display of the document in a browser application. If the element is compliant with the subsidiary standard, the element is displayed as normal. If the element is not compliant, the element is displayed with a visual indicator. An element may be generally any quantifiable subsection of the document, such as a form element, a table element, or a rendered representation of a block of code or markup language.

In another aspect, the document is a web page and there is a computerized method for verifying the web page's compliance to an accessibility standard. The method generally includes obtaining the web page; determining if an element of the web page is compliant with the accessibility standard; and displaying the web page using a browser application, showing the element as normally displayed if the element is compliant with the accessibility standard or showing the element displayed with a visual indicator if the element is not compliant.

In another aspect, a computer program product, which is tangibly embodied in an information carrier, is provided for verifying compliance of a web page to a subsidiary standard. The computer program product includes instructions that are operable to cause a data processing apparatus to obtain the web page; to determine if an element of the web page is compliant with the subsidiary standard; and to display the web page using a browser application. If the element is compliant with the subsidiary standard, the computer program product causes the data processing apparatus to show the element as normally displayed. If the element is not compliant, the computer program product causes the data processing apparatus to show the element displayed with a visual indicator.

In another aspect, a system for verifying document compliance to a subsidiary standard is provided. The system includes a computer system; browser software that resides in the memory of the computer system; and compliance software that also resides in the memory of the computer system. In this aspect, the compliance software is configured to obtain a web page; determine if an element of the web page is compliant with the subsidiary standard; and display the web page using the browser software. If the element is compliant with the subsidiary standard, the compliance software shows the element as normally displayed. If the element is not compliant, the compliance software shows element displayed with a visual indicator.

In another aspect, a system for verifying document compliance to a subsidiary standard is provided. The system in this aspect includes a means for obtaining a web page; a means for determining if an element of the web page is compliant with the subsidiary standard; and a means for displaying the web page using a browser application, showing the element as normally displayed if the element is compliant with the subsidiary standard or showing the element displayed with a visual indicator if the element is not compliant.

Implementations can realize one or more of the following features and/or advantages. In implementations of any of the aspects mentioned above, the subsidiary standard may be an accessibility standard as described in any of the following: the US Section 508, the UK Disability Discrimination Act, Canadian Common Look and Feel, eEurope Plan, the WCAG issued by the W3C, or guidelines established by a corporate policy.

In some implementations of the aspects herein, the document is a web page. The web page is typically composed of HTML or XHTML components, such as hyperlinks, as well as portions of scripting language code. A compliance tester, during compliance testing, will typically navigate the site, going from a first page to a second, by selecting hyperlinks on the first web page. As the user navigates the site, the techniques described herein determine the compliance of the elements on the web page the user is on (and in some embodiments in the pages the user previously navigated to). In some implementations, this involves executing scripting language code, e.g., cross-frame JavaScript found on either the first or second page, as the user navigates from one page to another. In other implementations, the aspects verify that a skip navigation element exists in/on the web page. When a skip navigation element exists, some implementations further determine if the skip navigation element is assigned an accesskey value. In other implementations, determining the compliance of elements includes determining the compliance of values assigned to an element's attributes, e.g., comparing an assigned alt-text value for the element with a preferred alt-text value for the element.

When an element of the document or web page is determined to be non-compliant with the standard, a visual indicator is typically displayed with the element, either above, below, alongside, or around it. Additionally, in some examples, an explanation of the non-compliance may be displayed when a cursor or mouse pointer is moved over the element or the accompanying visual indicator. This advantageously gives the user the ability to quickly ascertain compliance with subjective parts of the standards by flagging possible problems visually within their rendered context, rather than forcing the compliance tester to parse markup code.

In addition to visually indicating non-compliance of elements, in some implementations, compliance is additionally or alternatively indicated. In these implementations, if the element is compliant, a visual indicator is displayed indicating the compliance; the indicator typically displayed in a color different than that used to indicate non-compliance.

Using visual indicators to display compliance or non-compliance assists the compliance tester in making decisions about subjective requirements of the subsidiary standard. One such example of a subjective requirement of the standard relates in particular to tables. Tables serve a dual function in HTML. Though they are often used to present data in a spreadsheet-like manner, they are also effective, through cell border, width, and height manipulation, at positioning content. To comply with, for example, US Section 508, a table that utilizes a header row to display data in a spreadsheet-like manner typically has each cell of its header row enclosed in a table header (<TH>) tag. If the table, however, is used primarily to position content, no such requirement is imposed and no <TH> tags need be used. Some tools of the prior art flag every table header cell when the <TH> tag is missing, favoring over-inclusiveness rather than potentially missing a non-compliant element. Flagging every element as non-complaint is, however, at odds with the US Section 508 standard when the table is used primarily for positioning purposes.

Though prior art tools may assist the compliance tester in determining objective compliance, they are less useful, if at all, when determining subjective compliance. For example, outputting potentially dozens of lines of error messages for objective non-compliance with a subjective standard effectively buries the more useful, subjectively-oriented error messages. The automated tool described herein presents visual error indications to the compliance tester, allowing for a more subjective determination of a document's compliance. For example, if a table is used primarily for positioning and no header row is designated, i.e., no row is enclosed in a <THEAD> tag and/or no <CAPTION> element is defined, then no visual indication of non-compliance is presented. If a table row is designated as a header row, then the row as a whole has one visual indicator, e.g., a background color of dark purple, and each cell containing content enclosed in a <TH> tag is marked with another visual indicator, e.g., a background of dark blue. Using different visual indicators allows the compliance tester to discern which header cells do not have the proper enclosing tags since those cells have the same background as the <THEAD> (or <CAPTION>) row, rather than the background color of the <TH> cells.

Another example of non-compliance that is determined by the automated tool described herein is when a document or page does not include skip navigation, or includes skip navigation without an accelerator key. Skip navigation allows assistive document reader programs, such as JAWS, to jump over portions of the document that may be repetitive between subsequently viewed documents, or contain no new or meaningful content. Examples of elements that should include skip navigation are navigation links or menu links. These links typically contain static, site-level information that does not typically change between different documents. Because there is little difference page to page navigation-wise, the user often prefers to skip over navigation information, or at least process it in an accelerated manner.

In addition to determining element compliance for a given page, the automated tool may also use a browser interface to generate a report for any pages that the user navigates to or for the entire site. During this compliance testing navigation, in some implementations, no configuration or programming is needed to traverse the site, nor do any forms need to be filled out. The user simply navigates as they normally would through the site, the visual indicators of compliance and non-compliance being generated without specific input by the compliance tester.

Tools such as Bobby™ are useful to a website developer for reviewing multiple individual lines of non-compliant code. The present invention, however, is advantageous in that it provides a means for the business user or human resources staff member, rather than the website developer, to review the website for compliance against a subsidiary standard (such as an accessibility standard). Such compliance testers typically have little or no experience debugging HTML code and the error messages of the present invention allow the business user to not only determine that a problem exists, but visually where the problem is, as well as allow them to make subjective decisions about the page or site's compliance.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a process diagram showing a method for verifying document compliance to a subsidiary standard.

FIG. 2 is a block diagram of a system used for verifying document compliance to a subsidiary standard.

FIG. 3 is a screen shot generated by the automated tool highlighting non-compliant images on a web page.

FIG. 4 is a screen shot generated by the automated tool highlighting a server-side image map.

FIG. 5 is a screen shot generated by the automated tool highlighting non-compliant form elements.

FIG. 6 is a screen shot generated by the automated tool highlighting form elements that have accesskeys.

FIG. 7 is a screen shot generated by the automated tool highlighting document headings.

FIG. 8 is a screen shot generated by the automated tool highlighting non-compliant hard breaking links as well as bulleted lists.

FIG. 9 is a screen shot generated by the automated tool highlighting links with titles.

FIG. 10 is a screen shot generated by the automated tool highlighting skip navigation.

FIG. 11 is a screen shot generated by the automated tool highlighting various table elements.

FIGS. 12A and 12B are screen shots generated by the automated tool highlighting tables with multiple elements.

FIGS. 13A and 13B are screen shots generated by the automated tool highlighting a table mode that displays any nesting of tables.

FIG. 14 is a report generated by the automated tool highlighting non-compliant page titles.

FIG. 15 is a report generated by the automated tool highlighting non-compliant frame titles.

FIG. 16 is a report generated by the automated tool listing compliant link titles.

FIG. 17 is a report generated by the automated tool highlighting non-compliant skip navigations.

FIG. 18 is a report generated by the automated tool highlighting non-compliant form elements.

FIG. 19 is a report generated by the automated tool highlighting images found within the site.

FIG. 20 is a report generated by the automated tool highlighting non-compliant image maps.

### DETAILED DESCRIPTION

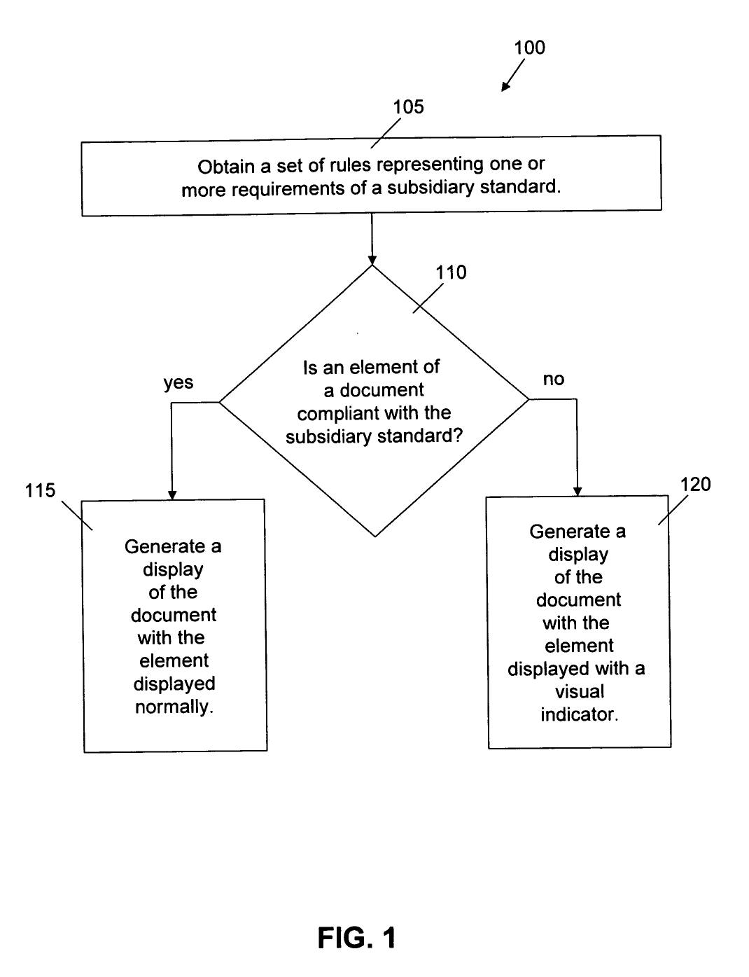

FIG. 1 is a process diagram showing a method for verifying document compliance to a subsidiary standard. The term document is used to describe an electronic representation of transmittable content. For example, a document may be represented in a computer-readable language, e.g., assembly-style data or code, whose contents include 1s and 0s. Alternatively, the document may be in a human readable form such as plaintext, hypertext markup language (HTML), extensible markup language (XML), standard generalized markup language (SGML), and/or SGML's derivatives, whose contents may include ASCII or Unicode text, or aural, visual, olfactory, tactile, and/or gustatory presentation components. The contents of the human-readable form may also be the code that renders the aforementioned presentation components or the presentation components themselves, e.g., the content may be data that, when rendered, generates an image. Additionally the content may be the visual rendering itself of the image.

In some implementations, the document is a web page. The web page/document (generally, document) may be stored on the local computer, e.g., in the file system of the computer's hard drive, located on a computer on a local or wide-area network, or located on a server accessible from the Internet. In implementations where the document is not located on the local computer, for example where the document is a web page residing on a computer accessible from the Internet, the document must first be obtained from the remote system, typically through a computer command such as the HTTP GET command issued by a web browser, which, using the HTTP protocol, requests a document from a server.

A document that is a web page generally complies with the HTML, or alternatively XHTML, standard as put forth by the W3C. These standards may be thought of as “rendering standards.” If the document does not comply with the rendering standard, typically a web page browser does not display the document as the author intended. A document may also comply with additional guidelines describing a second standard, i.e., a subsidiary standard, such as the US Section 508 web accessibility standard. The subsidiary standard represents a series of rules that one should follow if one wishes a document to be compliant. Compliance with the subsidiary standard is not required for the document to comply with the rendering standard and the document may in fact be displayed fully and completely without conforming to any portion of subsidiary standard. Complying with the subsidiary standard, however, generally allows additional users, e.g., users with disabilities, to access and utilize the document. Compliance with the subsidiary standard typically requires checking if elements of the rendering standard used in the document have appropriate or compliant properties and values (depending on the subsidiary standard).

For example, an “alt-text” element of the HTML standard, when implemented, typically is assigned a corresponding value. This corresponding value is displayed in the browser when an image is not viewable, that is, the text is the alternative to viewing the image. This allows the web site developer to textually describe the image to the site visitor in the event that the image source (“src”) attribute is not set correctly or the file containing the image is not available. Alt-text is especially useful for users that are visually impaired and cannot view even correctly defined images, since alt-text allows assistive browser applications to “read” the image to the user. To comply with the US Section 508 standard, for example, the alt-text value should typically reflect the text of the image if the text conveys an idea or message, and not convey an idea or message if the image is ancillary, such as representing merely a bullet image in a bulleted list of items. This reduces the amount of textual clutter an assistive browser must convey to the user. In a preferred embodiment, determining compliance occurs as follows: if the element being examined when parsing the document is an image, the automated tool further examines the alt-text attribute of the image. If the alt-text is defined, the tool displays the image as normal. If the alt-text is not defined, the tool displays the image with a visual indicator. In some embodiments the alt-text may be assigned, but may not be a preferred text value for the particular image. In those embodiments, the preferred text value for the image is defined by the user as a setting or input for the automated tool. The tool, when examining the alt-text of the image element, compares the image source file against the list of preferred images and upon finding the image in the preferred list, compares the element's alt-text against the defined alt-text for that image using, for example, a string comparison routine. If the two match, then the image is displayed by the automated tool as normal. If the element alt-text and the defined alt-text do not match, the automated tool displays the image element with a visual indicator.

FIG. 1 depicts one implementation of the method 100 which begins by obtaining (step 105) a set of rules representing one or more requirements of a particular subsidiary standard. The subsidiary standard may be US Section 508, or it may be one or more of following: the UK Disability Discrimination Act, the Canadian Common Look and Feel, the eEurope Plan, the WCA Guidelines set forth by the W3C, and/or guidelines established by a corporate policy of the individual or corporation that is authoring and/or publishing the document.

Once the subsidiary standard has been obtained (step 105), it is determined (step 110) if an element of the document is compliant. This is typically done by comparing the element and the element's attributes against the rules for an element of that type. Though the rules themselves, individually, are straightforward, many have subjective requirements and implementations that do not allow for a simple exercise in rule parsing to determine compliance. For example, as described above, an HTML table header row without each header cell having a <TH> tag may or may not be compliant with US Section 508. In such a case, the compliance is dependent on if the table is used primarily to position content or not.

If the element is determined (step 110) to be compliant, a display of the element is generated (step 115) with the element displayed normally. If the element is not compliant, a display is generated (step 120) showing the element along with a visual indicator. The display is typically generated (steps 115, 120) in a browser application such as Microsoft's Internet Explorer or the Mozilla Organization's Firefox browser. Where the document is not a web page, however, other document rendering applications are also contemplated.

Displaying elements with a visual indicator (step 120) allows the compliance tester to visually determine which elements are compliant and which are not, as well as why, without requiring her to manually parse a multitude of error messages. This reduces the complexity and the time spent testing for compliance and debugging. Advantageously, visual indicators allow the compliance tester to quickly make subjective judgments regarding the compliance of a particular element. For example, a content positioning-oriented table may visually indicate the presence of a non-compliant header row. The error, however may quickly be dismissed because the compliance tester can subjectively determine that the table is positioning-oriented and thus does not need to comply with that particular requirement of the subsidiary standard.

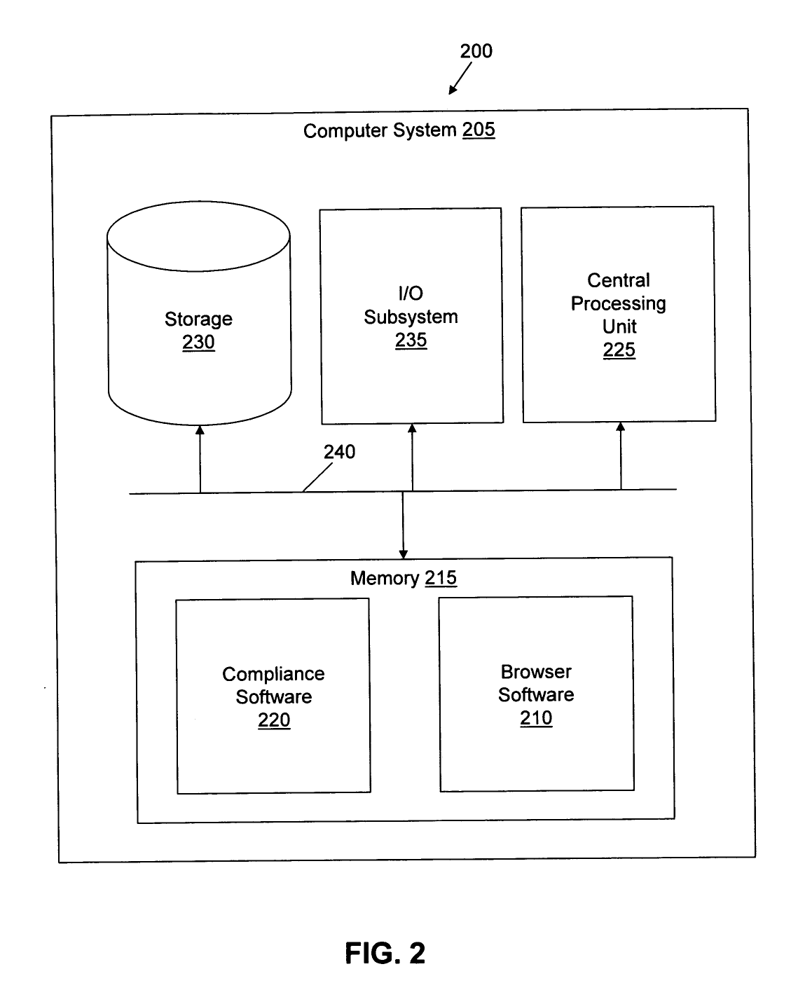

FIG. 2 is a block diagram of a system 200 used for verifying document compliance to a subsidiary standard. The system includes a computer system 205, browser software 210 residing in the memory 215 of the computer system 205, and compliance software 220 also residing in the memory 215 of the computer system 205. Other aspects of the computer system include a Central Processing Unit (CPU) 225 and a storage medium 230 such as a hard disk, rewritable CD-ROM (CD-RW), floppy disk, Compact Flash, and/or other non-volatile storage technology, an Input/Output (I/O) subsystem 235, and a communication system 240, such as a bus, that allows for signal communication between the memory 215, the storage medium 230, the CPU 225, and the I/O Subsystem 235. In implementations where the document is a web page, the browser software 210 is a standard web page browser as described above. The compliance software 220 is configured to perform the method described above in relation to FIG. 1.

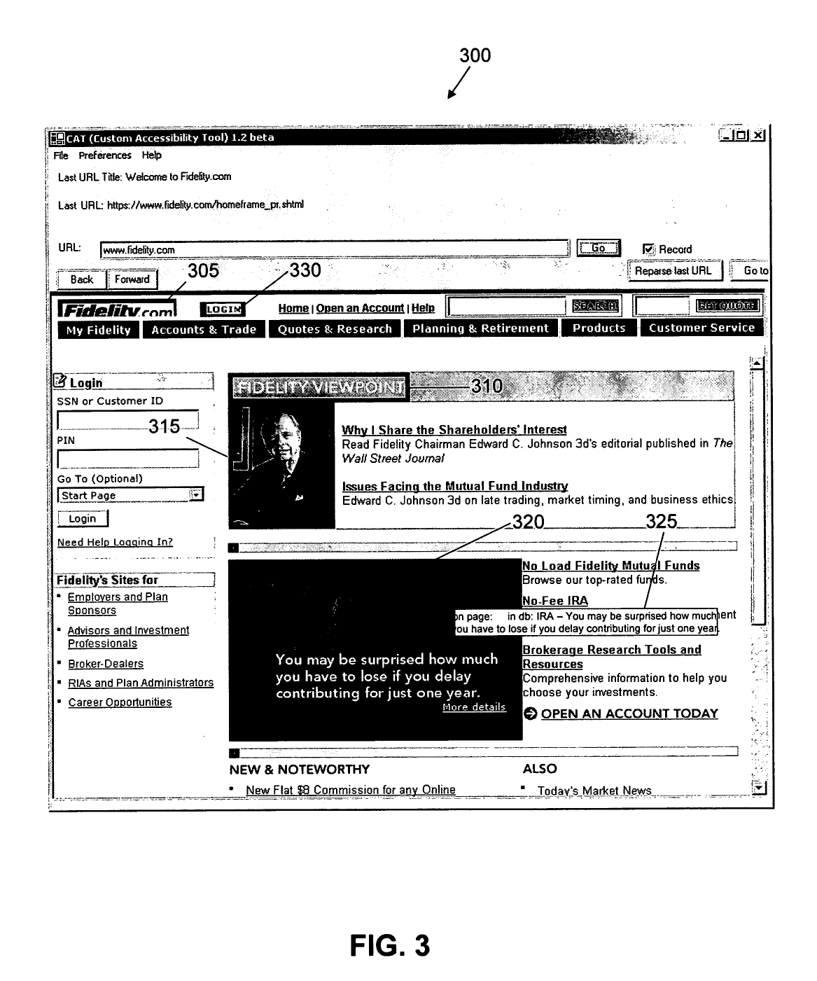

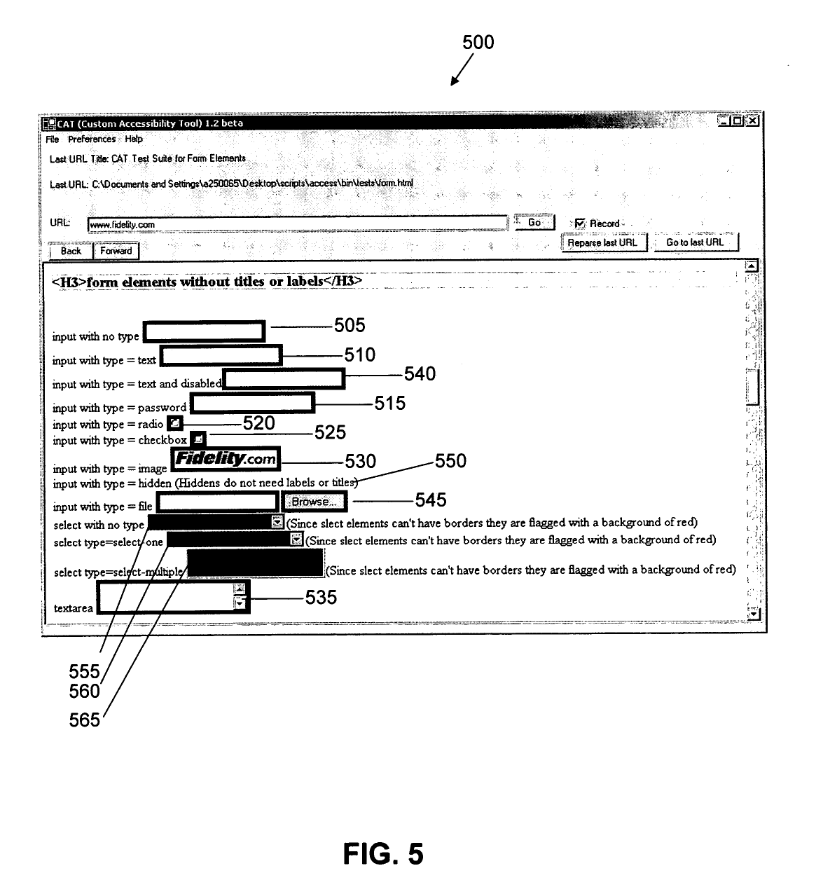

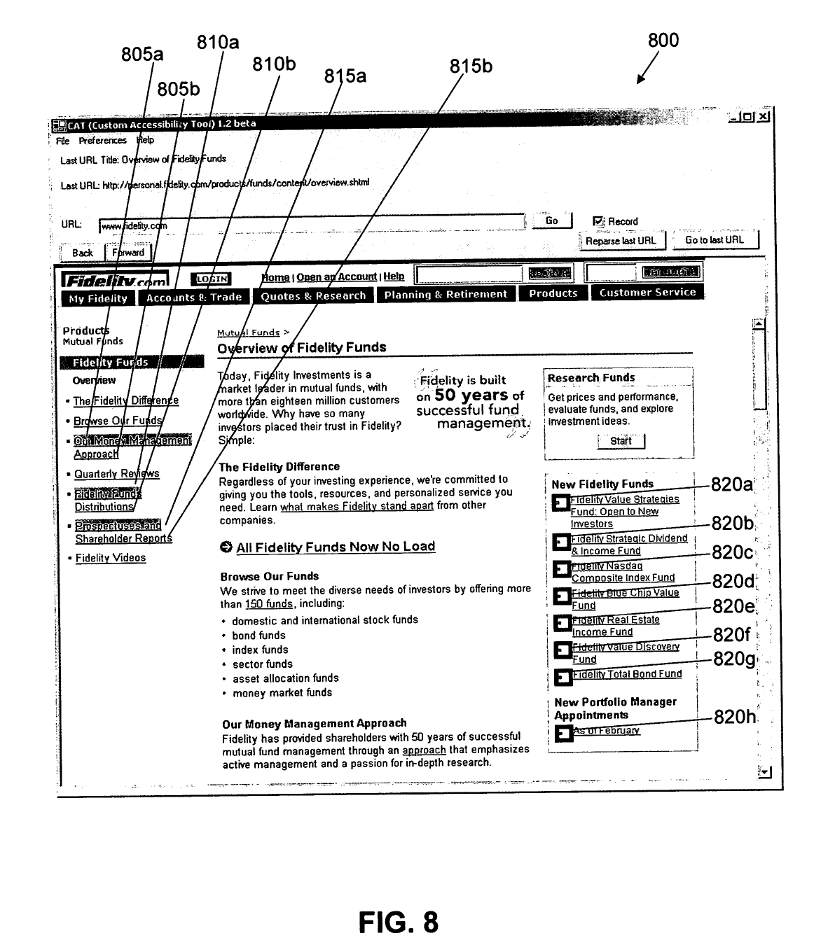

In some examples, a document or web page includes multiple elements that an implementation of the compliance software 220 tests for compliance against the subsidiary standard. Which element types are tested in a given test scenario is generally configurable via the compliance software's settings. Configuring different test scenarios allows the compliance tester to test as few or as many element types as desired for compliance at one time. FIGS. 3-20 are used to show how different non-compliant elements are displayed with their respective visual indicators. In cases where multiple element types are selected as testable, elements of any type that are determined by the compliance software 220 to be non-compliant are displayed with a visual indicator. As described herein, in some implementations, elements that are compliant are also displayed with a visual indicator, typically a different visual indicator than that for non-compliant elements. Scenarios testing multiple element types for compliance are found in, for example, FIG. 5, which displays visual indicators for various non-compliant input types, and FIG. 8 which displays both non-compliant lists and hyperlinks containing hard breaks.

FIG. 3 is a screen shot 300 generated by one implementation of the compliance software 220 described above, an automated tool, that highlights non-compliant images on a web page. This automated tool is also sometimes referred to as the Custom Accessibility Tool (CAT). According to some subsidiary standards, images without alt-text are not compliant. Examples in FIG. 3 of non-compliant images are the logo image 305, the title image 310, and the portrait image 315. In screen shot 300, these non-compliant images are outlined in a specific color (e.g., red). This colored border provides a visual indication to the compliance tester of the non-compliance of these elements.

In some implementations, a compliance tester may define a preferred alt-text value for a particular image during the configuration of the automated tool. This preferred alt-text value can be stored, for example, in a database (e.g., “in db”) If the particular image is found during testing and the alt-text for that image is not assigned a value, or the value assigned is not the defined alt-text, that image is also deemed not compliant. One example of an image with an alt-text attribute that is not assigned a value is a main content image (e.g., 320 if FIG. 3). When the alt-text for an image is not assigned (or does not match the alt-text value defined in the configuration) the image is outlined in a colored border (e.g., red). Additionally, in some implementations, the mismatched alt-text values are presented to the compliance tester as text (e.g., 325 of FIG. 3) when the tester moves the mouse pointer or cursor over the image 320 (in some implementations by replacing the alt-text of the image with the text describing the mismatched alt-text). As illustrated by the text 325 in FIG. 3, the alt-text “in page:” for the image is not assigned (i.e., no value follows the “in page:” prompt). The alt-text value defined in the configuration of the tool (i.e., “in db”) for that image, however, is “IRA—You may be surprised how much you have to lose if you delay contributing for just one year.” Because the alt-text in the page is different than the alt-text defined in the configuration, the main content image 320 is displayed with a visual indicator (i.e., outlined with a border, preferably red).

During the configuration process, a compliance tester may base alt-text definitions and/or values on site developer guidelines. An image having alt-text values that are different than those described by site developer guidelines is another example of non-compliance. In one instance, a site developer may include a bullet image and assign “bullet” as the alt-text value. Site development guidelines however, to encourage uniformity on the site, may specify that all bullet images have the alt-text of “*”. Using the same image but different alt-text may confuse an end-user and thus the practice may not comply with the corporate website standards, e.g., accessibility guidelines. Therefore, the tool visually indicates images that have an alt-text that is different than that defined by the standard (if defined in the standard) or as defined by the compliance tester as a preference setting of the tool.

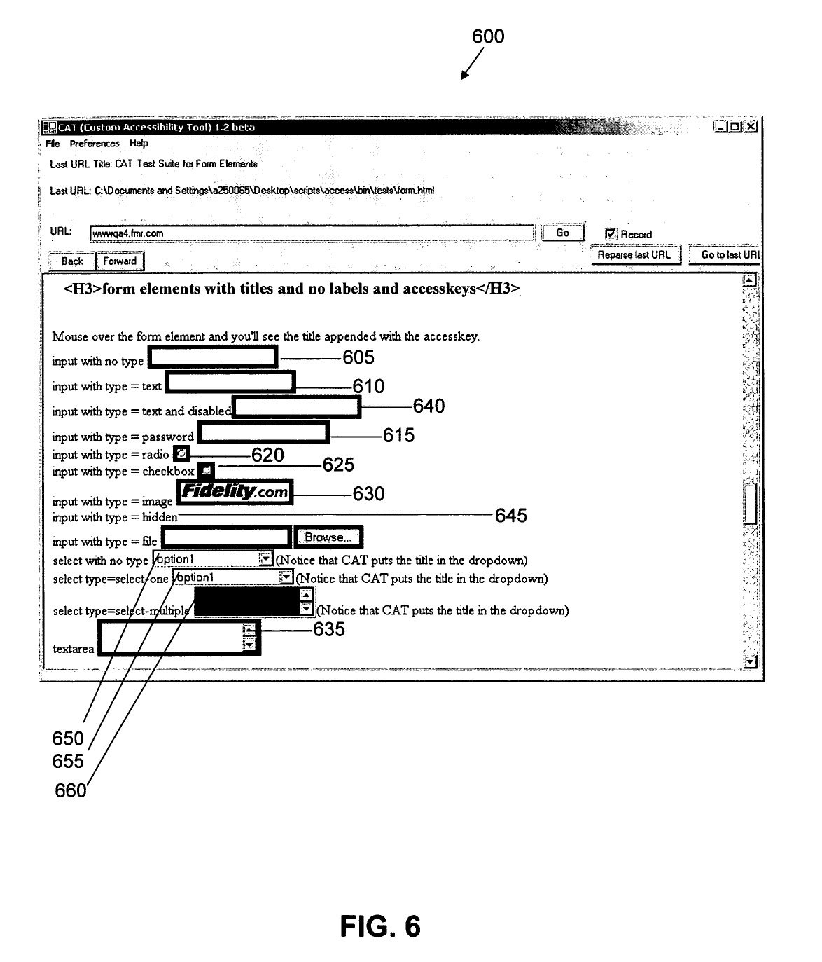

Images with accesskeys, such as the displayed login image 330, are displayed with a border of a different color (e.g., green). Accesskeys are described more fully with respect to FIG. 6.

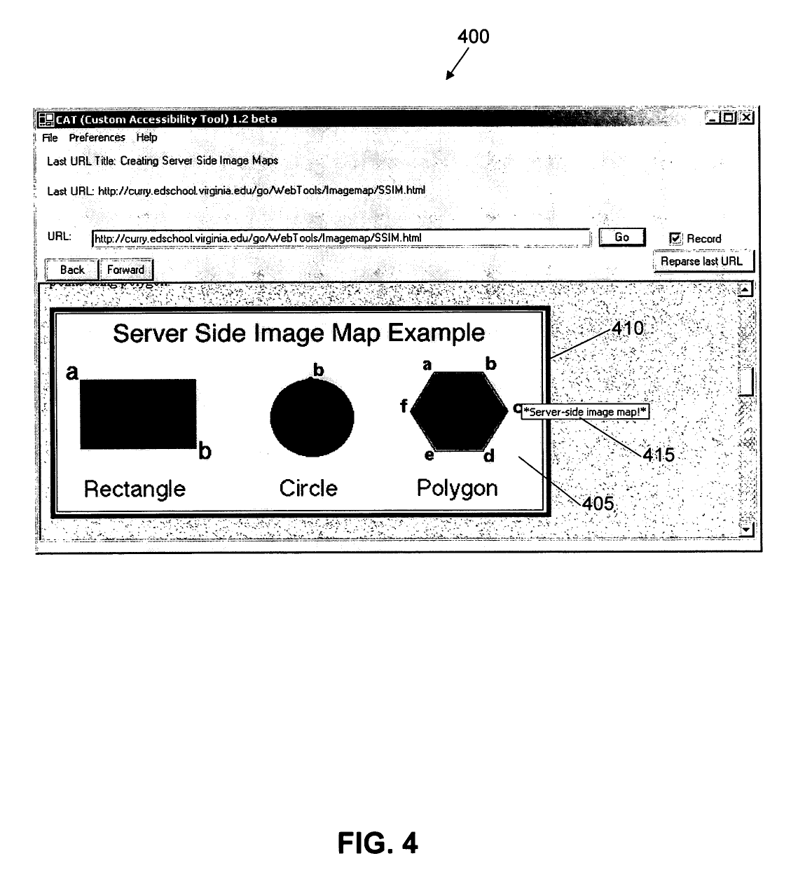

FIG. 4 is a screen shot 400 generated by the automated tool highlighting a server-side image map 405. In some versions, server-side image maps 405 are surrounded by a colored border 410, preferably red. Server-side image maps 405 are traditionally not compliant with accessibility standards because the processing of the user's click must be interpreted at the server. This generally does not allow accessibility programs on the client-side to give a user meaningful feedback when attempting to parse a server side image map 405. When encountered, in some versions, the automated tool presents, as a visual indicator, the alt-text 415 of the server-side image map 405 as “*Server-side image map!*” Additionally in some versions, the use of the server-side image map 405 by the site developer may be noted in a report (described below) of the site's compliance.

FIG. 5 is a screen shot 500 generated by the automated tool highlighting non-compliant form elements. A form element is typically any HTML/XHTML element enclosed by a pair of opening and closing <FORM> tags, i.e., <form><input type=text /></form> represents a text input form element. Other examples of form elements include, but are not limited to, images, buttons, radio buttons, checkboxes, textual inputs, and/or labels (inputs with no type defined default to “text”). Form elements typically have attributes defined which describe the properties or functionality of that particular element. Subsidiary standards often have compliance requirements for form elements and their attributes depending on the type of element. For example, if an <input> form element has a null or empty value for the “label” tag or “title” attributes the element is considered non-compliant and is displayed with a visual indicator For example, if the element 505 lacks a “label” or “title”, a border, preferably red, is drawn around the form element 505 indicating the element's lack of compliance. Other examples of form elements that, when lacking a label or title, are displayed with a colored border (preferably red) are those with input types of: “text” 510, “password” 515, “radio” 520, “checkbox” 525, “image” 530, and “textarea” 535. In one implementation, changing the border-color is accomplished by assigning a value to the border-color attribute in the document's style sheet. Disabled form elements 540 may also be displayed with a visual indicator. Though disabled form elements 540 are themselves not inherently non-compliant, they may be enabled using JavaScript and may have attributes which may lead to non-compliant behavior once enabled. Therefore, the automated tool displays the visual indicator to illustrate the existence of disabled form elements 540, and the compliance tester decides if the form element should be removed or not. Additional fimctionality is typically presented for other input types. For example, form elements 545 with “file” input types without titles or labels may be displayed with the visual indicator (again, a preferably red border) around both the filename input area as well as the accompanying “Browse . . . ” button. For form elements (not shown) with input types of “submit,” “button”, or “reset,” no title or label need exist. Instead, it is determined if their “Value” attribute has a non-null value. If the “Value” attribute is null or is not defined, then the visual indicator for those respective form elements is displayed. Hidden form elements 550, i.e., type=“hidden”, are typically not displayed with a visual indicator since they are not typically meant to be viewed by any typical user.

Special functionality is provided when a label and/or title are not present for form elements that do not have a “border” attribute, such as “select” boxes 555, 560, 565. Select boxes 555, 560, 565 typically have <option> sub-elements contained within them. Each option sub element describes an item in the dropdown list or select box 555, 560, 565. When a form element 555 is a select box and is determined not to be compliant, the background of each option sub-element of the select box 555 is changed. Some select box form elements 560 are specified as “single-select” select boxes. These single-select 560 select boxes are typically designated as such because the “multiple” attribute of the select box 560 does not have a “multiple” value assigned to it. That is, the “multiple” attribute of the select box 560 is null, not defined, or is assigned a value of generally anything other than “multiple.” When the single-select select boxes 560 are not compliant, they are displayed with a visual indicator much like non-compliant select boxes 555. When determined non-compliant, in this example by not having a title and/or label, the option sub-elements of the select box 560 are assigned a background color (e.g., red) that is different than the default or as assigned by the document's style sheet (e.g., white). In one instance this is done by assigning a color to the background-color of the style attribute of the select box 560 itself. In another instance this is done by iterating over the option sub-elements and assigning their background-color attributes a value different than that of assigned by the document.

Multiple-select select boxes 565, i.e., select boxes that have a “multiple” value assigned to their “multiple” attribute, use a similar visual indicator as the single-select select box 560 and the select box 555 to illustrate non-compliance. When a multiple-select select box 565 is not compliant with the subsidiary standard, the background color of the option sub-elements of the multiple-select box 565 is changed to a color (e.g., red) that is different than the default background color (e.g., white).

In addition, or alternatively, to the border or background changes described above as visual indicators of any of the described elements' non-compliance, in some implementations a descriptive message about the non-compliance, e.g., “missing label and title” is displayed when the compliance tester's mouse is moved over the non-compliant element. As described above, in some implementations, the tool tests multiple non-compliant elements and/or element-types for compliance at once (and displays the elements with as normal if compliant and with a visual indicator if not compliant). For example, FIG. 5 tests text inputs 510, images 530, and select boxes 555, for compliance (and displays them with visual indicators accordingly) all in one test scenario.

FIG. 6 is a screen shot 600 generated by the automated tool highlighting form elements that have accesskeys. Accesskeys, or more informally, “accelerator keys,” allow a user to access portions of a document by typing in a specific key or sequence of keys. For example, for a text input element where the user is expected to enter his or her name, if the text has an accesskey of “n”, i.e., accesskey=“n”, a user may use the “n” key to shift the focus of their browser to the name textbox (provided they are not focused on another text entry form element). In some versions, the user is additionally required to depress the “Alt” key first to use accesskeys. Accesskeys assists users who are limited in their ability to use a mouse or other pointer device. Typically any document element may have an accesskey defined for it, but accesskeys are especially useful for form elements.

Because form elements in particular benefit from the use of accesskeys, it is advantageous to determine which form elements have accesskeys defined for them and which do not. The automated tool creates a visual indicator if a document element, here a form element, has an accesskey defined. In some implementations the visual indicator is a border drawn around the element, the border color being different (e.g., green), than that used to indicate non-compliance as described above (e.g., red).

FIG. 6 illustrates an <input> form element 605 that has a null or empty value for the “type” attribute, that is tested to determine if an accesskey has been assigned to it. If the element 605 is assigned an accesskey, a border, preferably green, is drawn around the form element 605 indicating it is assigned an accesskey. Other examples of form elements that, when assigned an accesskey, are displayed with a colored border (preferably green) are those with input types of: “text” 610, “password” 615, “radio” 620, “checkbox” 625, “image” 630, and “textarea” 635. Additional functionality is typically presented for other input types. For example, form elements 640 with “file” input types without titles or labels may be displayed with the visual indicator (again, a preferably green border) around both the filename input area as well as the accompanying “Browse . . . ” button though the focus will typically shift to only the text entry portion of the element 640. For form elements (not shown) with input types of “submit,” “button”, or “reset,” their respective assignment of accesskeys may also be verified by displaying a colored border (e.g., green) around them. Hidden form elements 645, i.e., type=“hidden”, are typically not displayed with a visual indicator since they are not typically meant to be accessed by any typical user, nor does the site developer typically want the user to be able to accelerate to a non-visible portion of the form.

Special functionality is provided when an accesskey is present for form elements that do not have a “border” attribute, such as “select” boxes 650, 655, 660. When a form element 650 is a select box and is determined to have an accesskey, the background of each option sub-element of the select box 650 is changed to a particular color (preferably green). When single-select select boxes 655 are assigned accesskeys, the single-select select boxes 655 are displayed in a similar manner to select boxes 650 with no “multiple” variable assigned; that is displayed with the <option> sub-element colored a different color than the default defined by the browser, the document, or the document's style sheet. In one instance this is done by assigning a color to the background-color of the style attribute of the select box 655 itself before the document is rendered in the browser application 210. In another instance this is done by iterating over the option sub-elements and assigning their background-color attributes a value different than that of assigned by the document.

Multiple-select select boxes 660 use a visual indicator similar to the one used for the single-select select box 655 and the select box 650 to illustrate that accesskeys are assigned to the multiple-select select boxes 660. When a multiple-select select box 660 is assigned an accesskey in compliance with the subsidiary standard, the background color of the option sub-elements of the multiple-select box 660 are changed to a color (e.g., green) that is different than the default background color (e.g., white).

In addition, or alternatively, to the border or background changes described above as visual indicators of any of the described elements having accesskeys assigned to them, in some implementations a descriptive message about the accesskey (e.g., “accesskey=f”) is displayed when the compliance tester's cursor or mouse pointer is moved over the element with the accesskey.

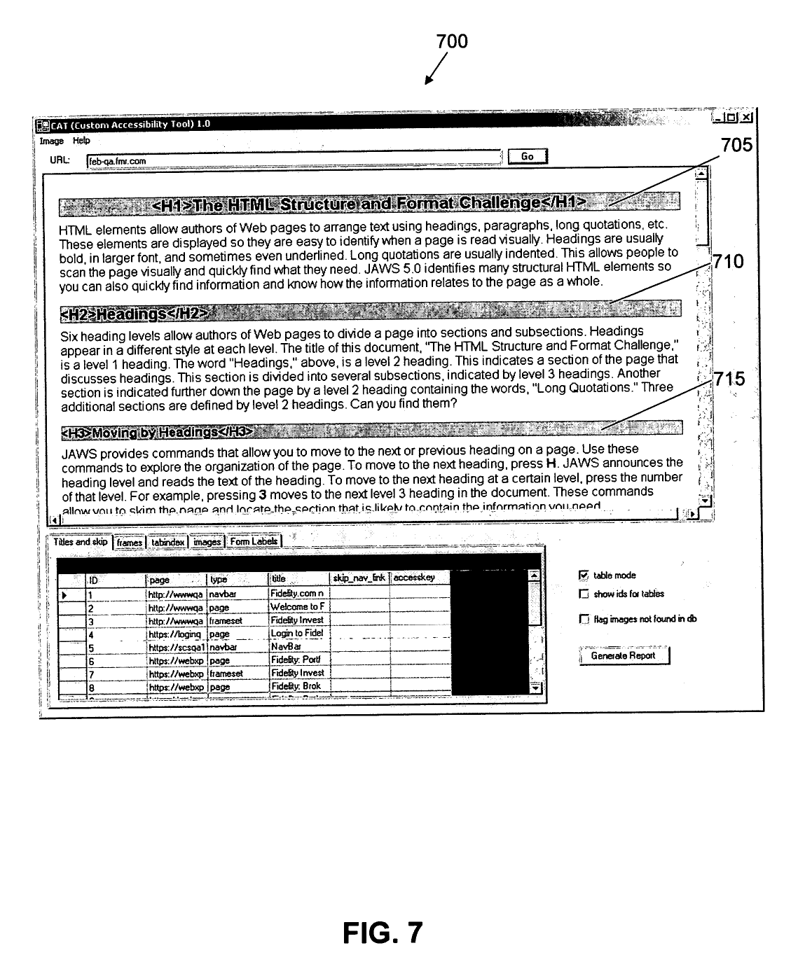

FIG. 7 is a screen shot 700 generated by the automated tool highlighting document headings 705, 710, 715. Document headings, when used correctly, create a general structure for the document that makes it easier for the reader to follow. For example, a top-level heading 705 typically states what the document is about, e.g., a document title. A top-level heading in HTML is typically enclosed in a pair of <H1> tags. A sub-heading 710, typically enclosed in a pair of <H2 > tags, generally describes a portion of the document such as a chapter or a particular theme. Sub-headings 710 may also include content that is further denoted by a sub-sub-heading 715. Sub-sub-headings 715 typically describe a single idea within a theme and are enclosed in a pair of <H3> tags. There may be several sub-sub-headings 715 sections per sub-heading 710 section. Further theme decomposition may be accomplished by further classifying subsections within the document. HTML in particular allows for six levels of headings, i.e., <H1>, <H2>, . . . <H6>. In addition to providing document organization, headings 705 and their sub-headings 710, 715 (as well as heading levels 4, 5, and 6, not shown) allow assistive browsers to present document sections to a user. For example, using a sub-heading 710, an assistive browser such as JAWS would typically announce the text of a particular sub-heading 710. If the user did not want to have that section read to her, she would press the “H” key and JAWS would advance to the next sub-heading at that level. To advance to a heading 705, 710, 715 of a different level, the user would press the number corresponding to that heaving level, e.g., “2” to advance to the next <H2> level heading, “4” for the next <H4>. In some implementations, to assist the compliance tester in determining which areas of content are headings, the automated tool visually displays a colored background, preferably blue, for headings 705 and sub-headings 710, 715, thus distinguishing them from the background color of the document as well as general content.

FIG. 8 is a screen shot 800 generated by the automated tool highlighting non-compliant hard breaking links as well as bulleted lists. Some assistive browsers such as JAWS parse document formatting information as content separation information. For example, to constrain a hyperlink to a particular width, a site developer may break a hyperlink composed of several words across two lines using a <BR> tag or by using two separate hyperlinks that point to the same target page. In scenarios where the site developer uses a <BR> tag, text that comes before the <BR> tag will typically be rendered on the line above the text that comes after the <BR> tag. This is not generally an issue for end users using a typical web browser, as the users are able to mentally tie the visual rendering together as a single idea or hyperlink. Some assistive browsers however, in an attempt to discern areas of content, will render these two lines as different portions of text. JAWS, for example, would typically announce to the user “Our Money Management” 805a as one hyperlink. When prompted to move to the next hyperlink, JAWS would announce “Approach” 805b. This, however, is not the unified concept of “Our Money Management Approach” 805a, 805b. Alternatively, “Our Money Management” 805a may be enclosed by one set of hyperlink tags, (e.g., <a href=“/our-money-management-approach.html”>Our Money Management</a>) and “Approach” 805b may be enclosed in another set of hyperlinks (e.g., <a href=“/our-money-management-approach.html”>Approach</a>) targeting the same webpage as the Our Money Management 805a link (i.e. /our-money-management-approach.html). In scenarios where the site developer uses hyperlinks that target the same page, the automated tool, when parsing the webpage, compares the target page of one hyperlink with the target of a another hyperlink and if the targets are the same, the automated tool displays the same visual indicator as if the two hyperlinks were one with a hard break in the link text.

The automated tool described herein visually displays groupings of words in a hyperlink that are broken by a hard break, e.g., a <BR> or similar tag, or by multiple nearby hyperlinks targeting the same page, by utilizing different coloring schemes to denote words before and after the hard break. To highlight both sections of text, typically the background of hyperlink text before the break (e.g., 805a, 810a, 815a) is colored one color, preferably orange, while the background of the hyperlink text after the break (e.g., 805b, 810b, 815b) is colored a different color, preferably yellow. This allows the compliance tester to quickly determine which links may cause assistive browsers parsing issues, rather than iteratively using the assistive browser itself to read out the entire document to find hyperlinks with hard breaks.

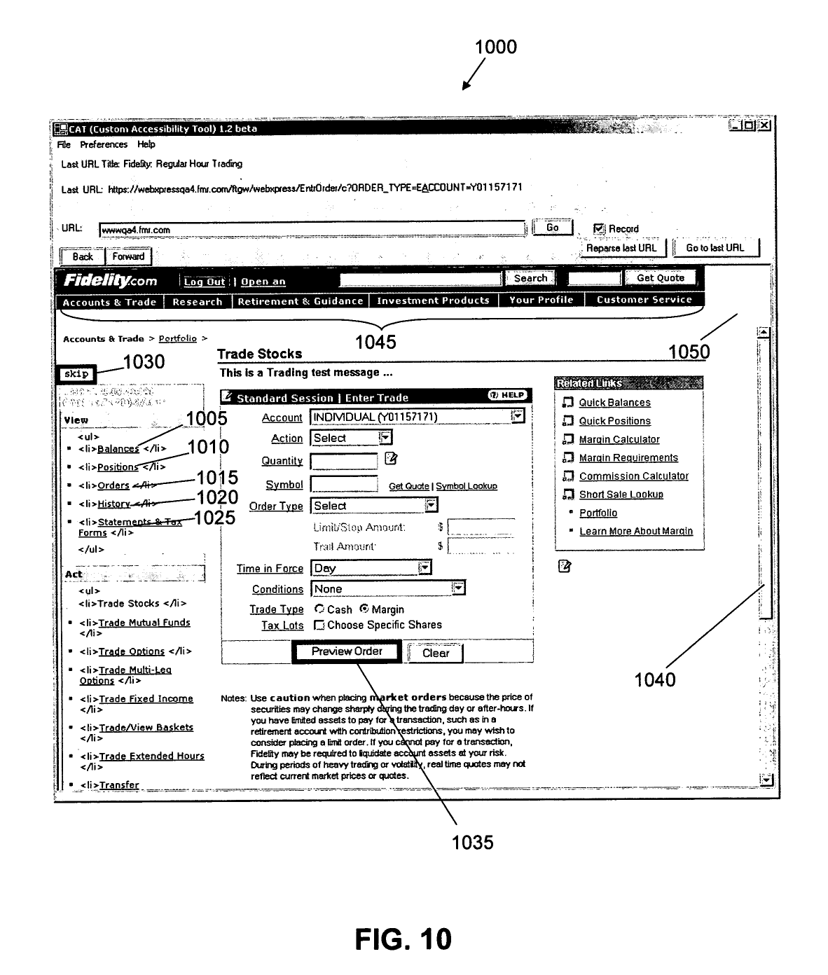

In addition to visual indicators for hard breaking links, the automated tool visually indicates which elements are <list item> elements (e.g., 820a . . . 820h. generally 820). List items 820 are typically enclosed within a pair of <li> tags, which, in turn, are enclosed in a pair of <ul> or <ol> tags and together make up a bulleted list (for example, see elements 1005 to 1025 of FIG. 10). Assistive browsers often allow a user to navigate a list or skip it altogether. By visually indicating which elements on the page make up lists, the compliance tester can quickly determine how an assistive browser will present the page content to a user.

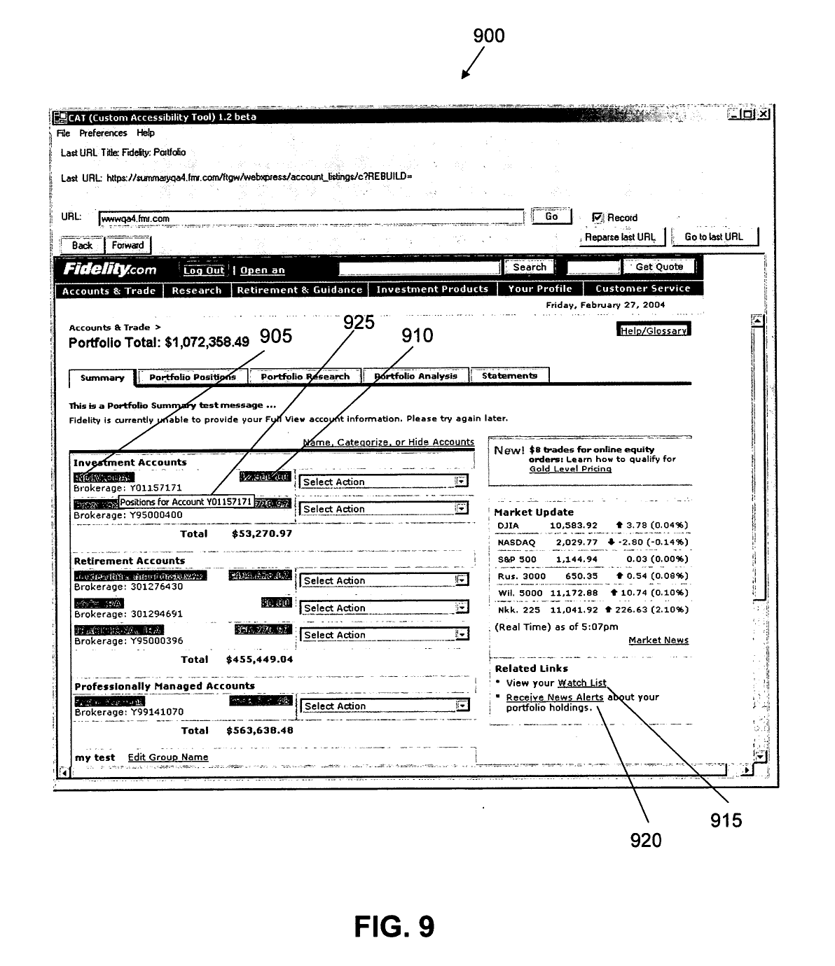

FIG. 9 is a screen shot 900 generated by the automated tool highlighting links with titles. Assigning titles to links allows a site developer to further explain what a hyperlink points to. Links with titles, while not non-compliant, are generally preferred because the use of a title adds information to the document, typically further assisting users that utilize assistive browsers in making their navigation decisions. Typically hyperlinks 905, 910 that are assigned titles will be highlighted in a particular color, preferably lime green, to distinguish them from hyperlinks 915, 920 that do not have a title associated with them. In FIG. 9, the hyperlink “INDIVIDUAL” 905 has a background different than that of the “white space” around the hyperlink 905. The balance indicated by the hyperlink “$2,500.00” 910 is also rendered with a different background color than the default background. Hyperlinks without titles 915, 920, however, are displayed as normal, with no alternate background coloring. In addition to visually displaying a different-colored background, the title of the hyperlink may be displayed by moving the cursor or mouse pointer over the hyperlink, thus allowing the compliance tester to determine if the title is an appropriate one for that particular hyperlink. For example, the title 925 of the hyperlink 905 may be displayed by moving the cursor or mouse pointer over the hyperlink 905.

FIG. 10 is a screen shot 1000 generated by the automated tool highlighting skip navigation. As described herein, skip navigation allows a user of an assistive browser to “skip” ahead to content on the page. Typically a user will want to skip over headings and navigation options that they have encountered on other pages. It is typically not useful for a user to hear that a page has options for Balances 1005, Positions 1010, Orders 1015, History 1020, Statements & Tax Forms 1025, etc. on every page. Instead, it is more useful to present to a user, at a location before the presentation of site navigation, e.g., Balances 1005, Positions 1010, etc., a skip button or hyperlink 1030 that, when activated or clicked, brings the user to a preferred area on the document, e.g., the middle of the page where stock trading information is presented. If a user wants to place or preview an order (after filling out the form and clicking the Preview Order button 1035), it makes little sense to force the user to wade through the navigation links 1005 . . . 1025 that are presented on each page of the site.

The automated tool utilizes two methods to determine the presence of skip links. In one implementation, the tool test for a “clear” or “transparent” image 1030, e.g., an image that is generally the same color as the background of the document so that it is virtually indistinguishable from the background. In FIG. 10, the transparent image 1030 additionally displays text of “skip” for the reader's clarity. If the tool finds a transparent image 1030, the automated tool determines if the image has “skip” assigned to its alt-text value. If the image is both transparent and has skip assigned to its alt-text value, the automated tool next determines if the image is enclosed by a pair of hyperlink tags, e.g., <a href=“. . . ”></a>. If these conditions are met, the automated tool deems the skip link compliant. Another type of skip link, however, may also be considered compliant. A hyperlink that is not an image, but instead is a textual hyperlink, may also be a skip link. If the hyperlink has “skip” assigned as its title and is also assigned an accesskey, preferably an accesskey of “2” or “Alt-2”, the tool also considers the hyperlink a skip link. Both of these implementations allow for a user to skip over redundant navigation 1005 . . . 1025 or table of contents hyperlinks. When a skip link 1030 is found, the automated tool visually indicates the skip link by displaying a colored border. The color of the border signifies if the skip link 1030 is generally compliant with the subsidiary standard. In some implementations, the border is a green color when the skip link is compliant with the subsidiary standard. If the skip link 1030 is not fully compliant, e.g., when the skip link has an accesskey defined, but not given a value of “2” (or alternatively “Alt-2”), the automated tool displays a border surrounding the skip link 1030 using a different color, e.g., red. Using different colors to designate skip links 1030, and their different levels of compliance, allows the compliance tester to quickly determine which skip links 1030 are needed as well as which skip links 1030 need to have their properties changed, e.g., their accesskey assigned a different value. Skip navigation is typically not used to navigate between framesets. Skip navigation is primarily used to navigate within a single frame, e.g., as depicted in FIG. 10, the skip link 1030 is contained within the frame bounded vertically by the scrollbar 1040. The skip navigation does not apply to the navigation 1045 in the top frame 1050.

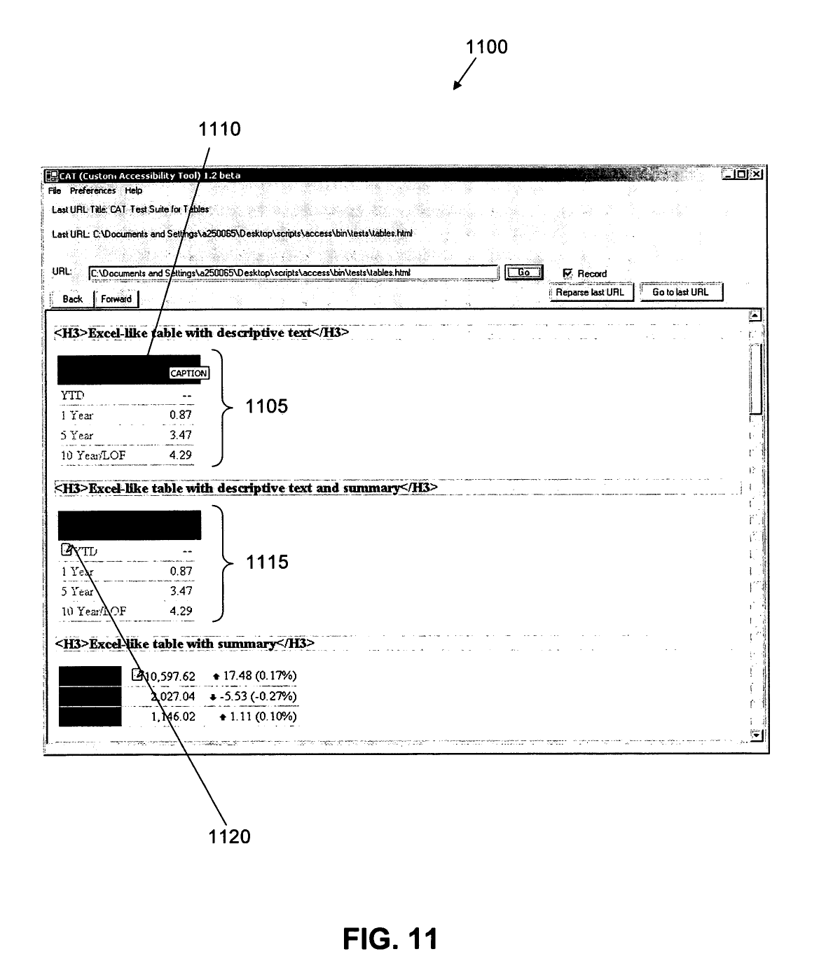

FIG. 11 is a screen shot 1100 generated by the automated tool highlighting various table elements. Rather than require a user to listen to every element of a table 1105 to discern its overall meaning, it is generally beneficial to add descriptive text 1110 to a table 1105 to explain the theme of the table 1105. As such, a subsidiary standard typically requires a site developer to add descriptive text 1110 such as a caption element to a table 1105. Typically, the caption 1110 appears located within the table and is viewable in a browser application. It is typically unclear though if a sub-element describing the table is a caption 1110 or simply data in table row because both are presented similarly to the user. Moving the cursor or mouse pointer over the text 1110 reveals if the text is a caption 1110 or not. It is inefficient, however, to move the cursor or mouse pointer over every table 1105 to determine if text in the table is a caption 1110. Instead, as described herein, it is advantageous to change the color of the background of captions 1110 (or, alternatively <TH> tags) to a color, preferably purple, that is different than the background of the table 1105.

In addition to determining and visually indicating if a table 1105 is assigned a caption 1110, the automated tool also visually indicates the presence of a table summary (not shown) if one has been assigned to a table 1115. Whereas captions 1110 are visual text and describe the table 1105 for all users, summaries are not displayed and are used almost exclusively by assistive browsers and document reader programs to further define visual text and describe the table 1115. Because summaries are used almost exclusively by assistive browsers, the actual summary is not illustrated in FIG. 11 since a regular browser does not display it. This presents a problem when a compliance tester is attempting to verify the existence of a summary of a table 1115. Rather than parsing the cumbersome document code, the automated tool instead displays a particular image 1120 inside a table when that table contains a summary. In some implementations, the image is a pad with a pencil graphic 1120. In other implementations, other indicative images are used. Using a particular image (e.g., 1120) to denote the use of a summary (or the lack of a picture 1120 to denote the lack of a summary) allows the compliance tester to quickly determine if a table 1115 has or requires a summary.

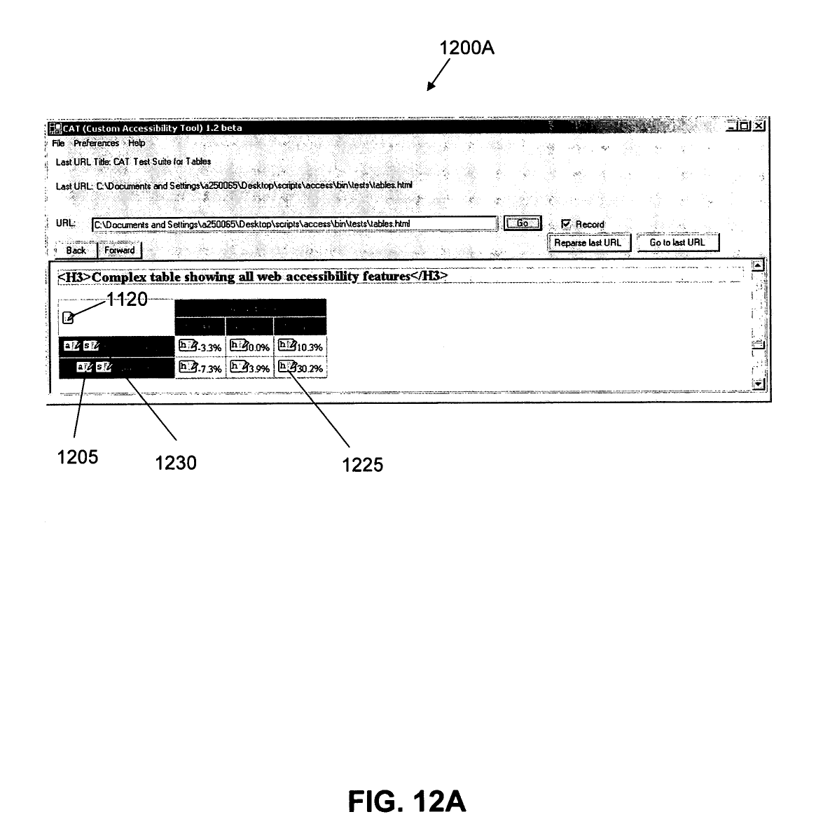

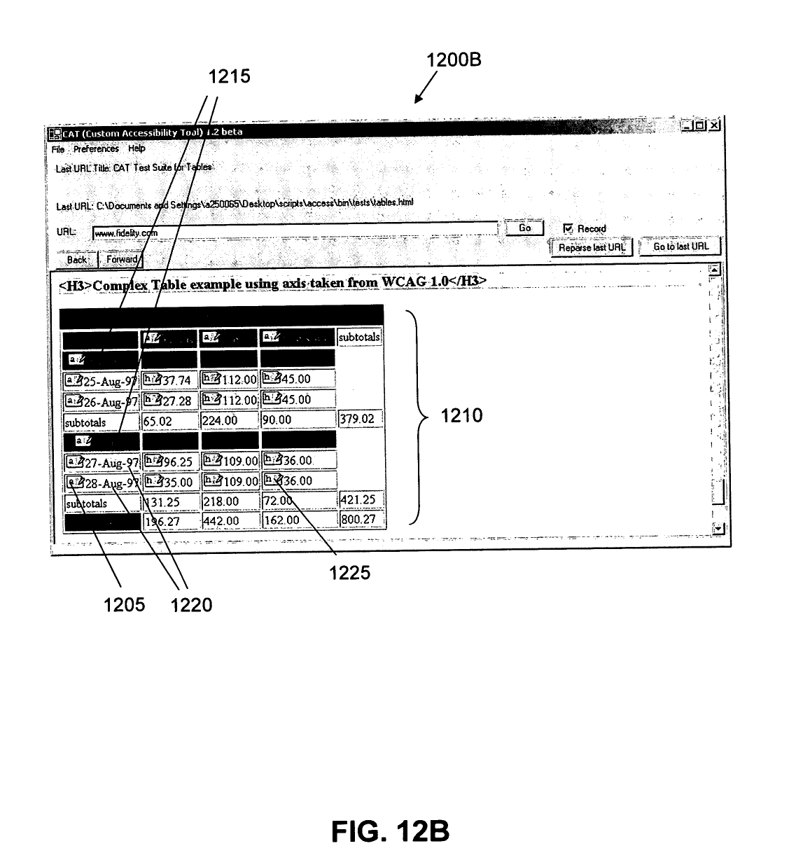

FIG. 12A is a screen shot 1200A generated by the automated tool highlighting tables with multiple table elements. In addition to testing for a summary and displaying a visual indicator 1120 for the presence of the summary, the automated tool also tests for axis attributes and scope attributes. Axis attributes group a list of related table cells into categories and are depicted by a pen and pad with an “a” on the pad 1205. Axis attributes are further described in relation to FIG. 12B. FIG. 12B is a screenshot 1200B generated by the automated tool highlighting tables with multiple axis elements. The screenshot 1200B depicts an exemplary expense report 1210 for a business trip. The report categorizes expenses first by city 1215 where the expense occurred and then by date 1220. Both attributes, city 1215 and date 1220, are located along the vertical axis of the report table 1210. Axis elements are typically used for complex tables to categorize headings (i.e., <TH> elements). The graphic of the pen and pad with the “a” 1205 indicates that each element along the left side is an axis element.

In addition to summary and axis attributes, data cells that reference headers are also tested for compliance by the automated tool. When a data cell that references a header is found, a visual indicator 1225 denoting their presence is displayed (data cells that reference headers 1225 are found in FIGS. 12A and 12B). Headers (<TH>) are data used to describe the type of data in a column of cells. Typically, table cells in that column reference the <TH> tag's ID attribute in the table cell's “headers” attribute. For example, a table cell, (e.g., <TD>) may have a headers attribute defined (e.g., <td headers=“myHeader”>). The header myHeader has an attribute “id” with the value “myHeader”(e.g., <TH id=“myHeader”>). The table cell now refers to that header as the table cell's header. Similar to the test for a summary, when a table cell references a header, an image 1225 is displayed in the table cell, preferably an icon of a pencil and pad with an “h” on the pad. If a header is not defined, but a reference back to a <TH> exists, the image 1225 denoting the “orphaned” reference is typically then surrounded by a colored border, preferably red, to indicate its non-compliance.

Referring back to FIG. 12A, scope attributes 1230 describe and are denoted by a pen and pad icon 1225 with an “s” displayed on the pad. The scope attribute assists a user in determining if text in a column/row is primarily associated with the column or primarily with the row. Associating the text with the row tells the compliance tester that items in that row are associated with that row. Alternatively, the scope attribute could be set on the column header and items in that column would be associated with the column. Beneficially, for an assistive browser, the association made by the scope attribute may precede each value as it is read, rather than the user attempting to guess the categorization.

For example, as illustrated in FIG. 12A, displaying a pen and paper icon with an “s” indicates that the “Mid-Cap Growth” text has a scope attribute defined in either the pair of <TH> tags surrounding the text, or as part of the <TR>, or “table row”, tag defining that HTML table row. Values in the row “Mid-Cap Growth”, (i.e., −3.3%, 0.0%, 10.3%) are therefore all associated with “Mid-Cap Growth”. In some implementations, an assistive browser would then read the row values as “Market-Cap Growth, −3.3%”, “Market-Cap Growth, 0.0%”. This is beneficial in that the reader is able to determine that the value of −3.3.% (and 0.0%) is associated with Market-Cap Growth primarily instead of “1 Year”. Had the column header “1 Year” been designated, in some implementations the assistive browser would read the column as “1 Year, −3.3%”, “1 Year, −7.3%” which the compliance tester may determine to be less useful to the reader than having “Market-Cap Growth” primarily associated with the value.

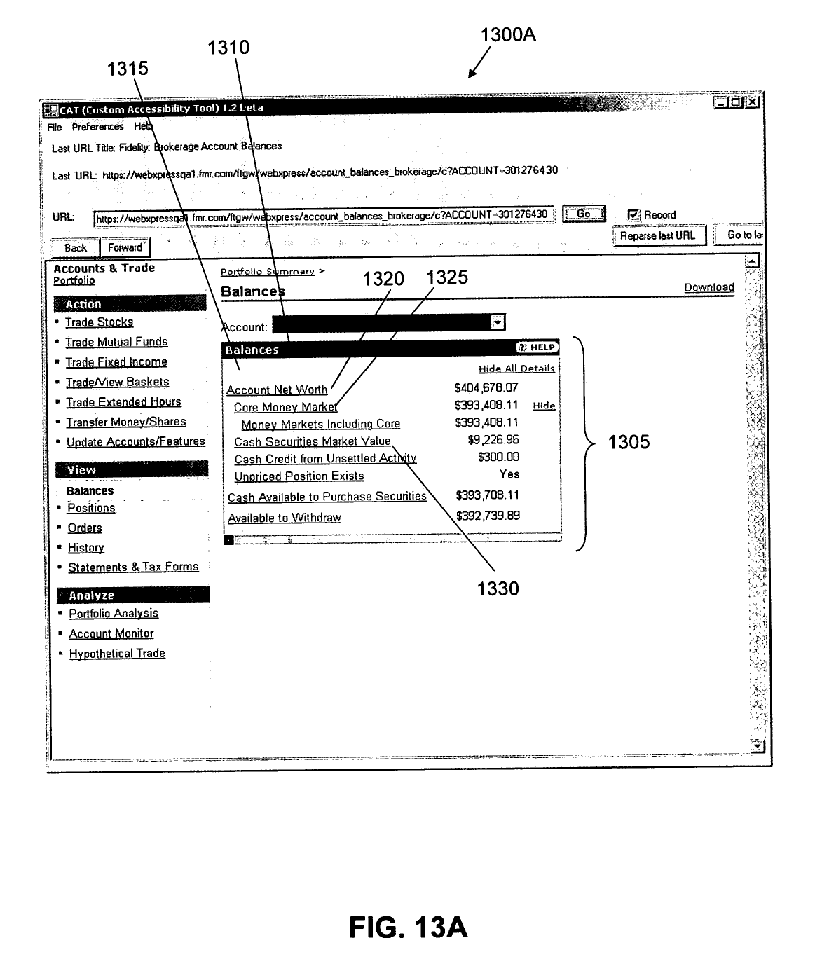

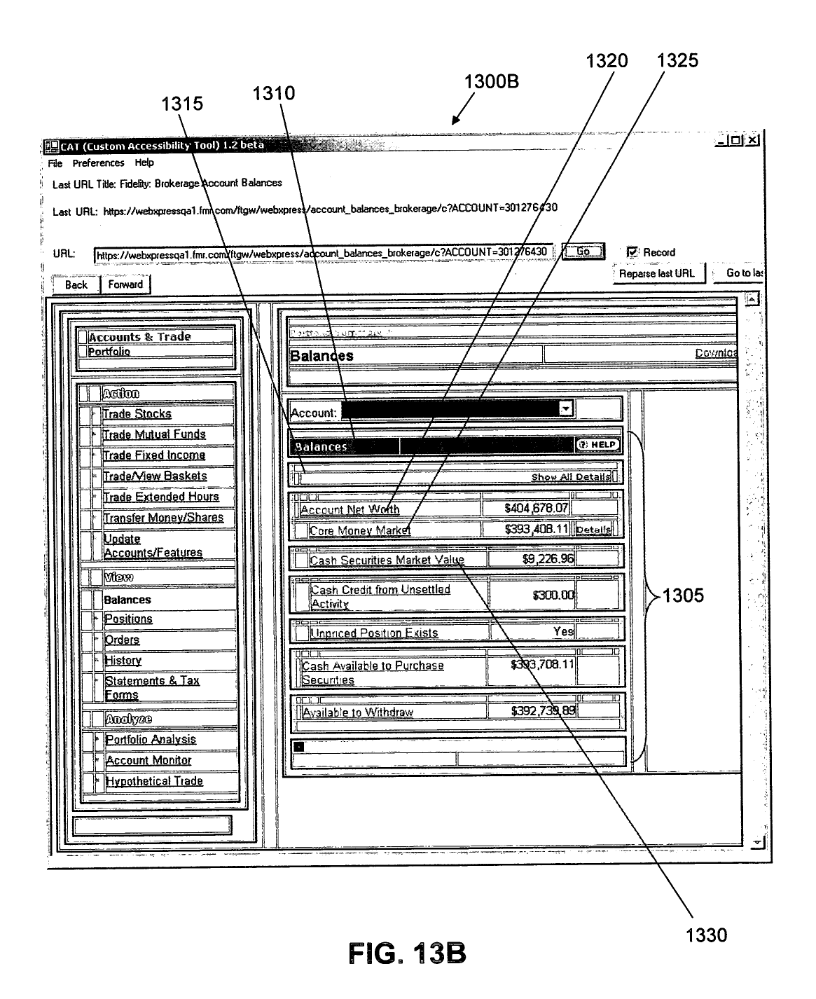

FIGS. 13A and 13B are screen shots 1300A, 1300B generated by the automated tool highlighting a table mode that displays the nesting of tables. Assistive browsers such as JAWS often have a “table mode” that allows a user to more easily navigate tables. For example, after entering table mode, a user may elect to use commands such as “Next Table” which moves the cursor or mouse pointer focus to the next table, or “Prior Table” which shifts the focus to the previous table. This is generally useful for navigating a document that may include spreadsheet-like data. FIG. 13A represents a document as the document appears before entering table mode. As displayed in the screen shot 1300A, there is generally one main content area, i.e., the box entitled “Balances” 1305. By looking at the document as normally rendered, one may generally ascertain that one table is used for the Balances box 1305, with one row 1310 containing the heading “Balances” and another row 1315 containing the content “Account Net Worth” 1320, “Core Money Market” 1325, and other hyperlinks. By looking at the document as rendered, the user has a difficult time determining what positioning elements are used to align content in the table since not all of the hyperlinks are left justified, e.g., “Cash Securities Market Value” 1330, or on the same horizontal plane, e.g., hard breaks (<BR>) or <p> tags (paragraph breaks) may be used to vertically position content.

FIG. 13B depicts the document of FIG. 13A as the document is generally composed element-wise by the site developer. Developers often utilize layer upon layer of nested tables to position content. Because these tables may have borders of zero width and no background color, they are not typically visible to a user viewing them in a standard browser (other than causing table cell components to shift right or left, up or down). An assistive browser, however, presents the table as the table appears in FIG. 13B, after the browser entered table mode. Instead of one table, the Balance Box 1305 is in fact nine separate tables, each table containing layers of additional table elements. The single row of the Balance header 1310 is made up of a two-row table. The second row 1315 of the Balance table 1305 of FIG. 13A is actually several tables, one of which includes “Account Net Worth” 1320 and “Core Money Market” 1325. “Cash Securities Market Value” 1330, originally presented as being in the same table as “Account Net Worth” 1320 and “Core Money Market” 1325, is in fact in another table entirely. Viewing the content 1305 this way, that is, as composed by the site developer, allows the compliance tester to determine if tables used to position content have become too cumbersome for a disabled user to traverse if the tables are being read aloud to her via an assistive browser. Navigating the table structure of FIG. 13B using command such as “Next Table” and “Previous Table” would likely confuse a user of an assistive browser to the point that the user may leave the website in frustration. Thus it is advantageous to view table elements in a manner that is similar to the way an assistive browser “sees” them. This furthers the goal of compliance by tasking the site developer to develop less complex methods of arranging content on a site, thus allowing more visitors to traverse the content contained therein.

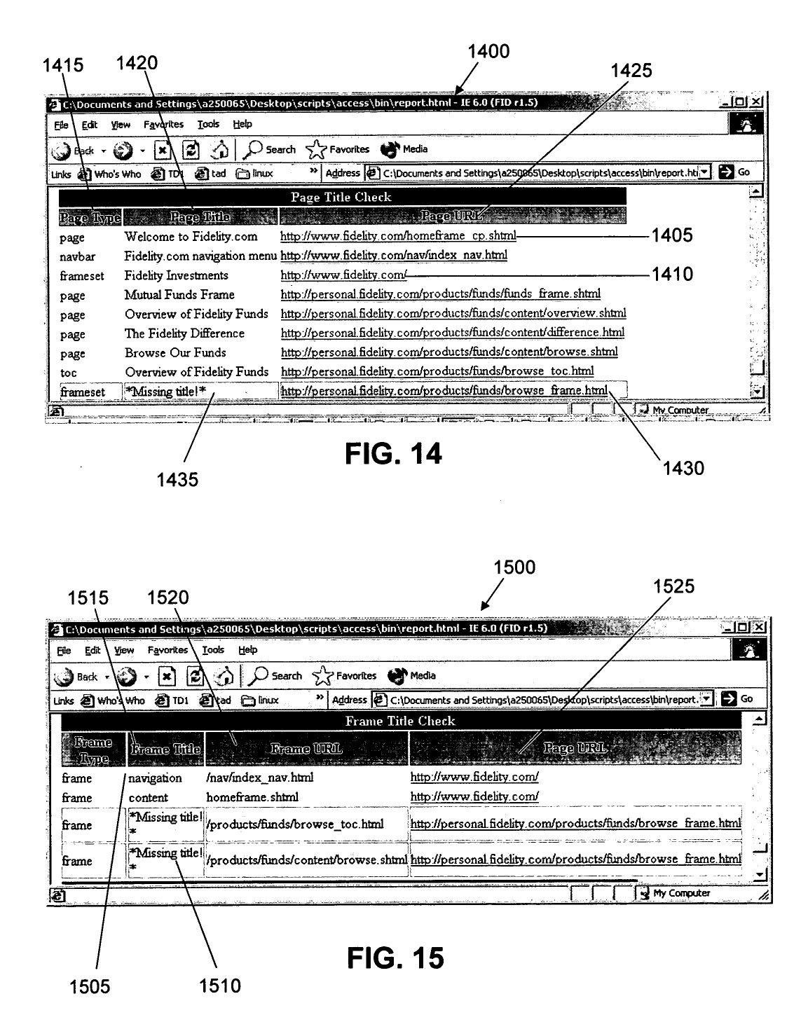

In addition to displaying documents as they would be rendered, the automated tool is useful in generating reports of the non-compliant elements found on each page, or within the entire site. FIG. 14 is a report 1400 generated by the automated tool highlighting non-compliant page titles. This report in particular described the compliance of documents for a given site. Documents with titles, e.g., the welcome page 1405 and the frameset 1410, are both noted as compliant, the automated tool displaying the page type 1415, the title 1420, and the location of the page 1425. A non-compliant page, e.g., a different frameset 1430, is missing a title and is denoted as such via the “*Missing title!*” 1435 entry in the report 1400. Additionally, the background color of the table cell in which the non-compliant element is reported is a different color, preferably pink, than that of the compliant elements 1405, 1410 listed in the report. The report is beneficial in that it describes to the compliance tester all of the non compliant pages within a site. The tool's report displays to the compliance tester those pages have non-compliant elements, the tool providing hyperlinks to the non-compliant pages. The compliance tester then clicks on a hyperlink and is taken to the non-compliant page. The tool displays the page, displaying the compliant elements as normal and the non-compliant elements with a visual indicator. In some versions, the linked-to page visually indicates only the elements that are non-compliant for that test scenario, e.g., if the tool is configured to display only image alt-text that is non-compliant, only non-compliant images will be displayed with a visual indicator, the tool ignoring any other non-compliant elements. In other versions, the tool visually indicates any and generally all non-compliant elements on the linked-to page, or, alternatively, both compliant and non-compliant elements.

FIG. 15 is a report 1500 generated by the automated tool highlighting non-compliant frame titles. Much like the report 1400 on frameset and page title compliance, individual frames may be reported as compliant 1505 or non-compliant 1510. The report has columns for the frame titles 1515, the frame URLs 1520, and hyperlinks 1525 to the actual frames.

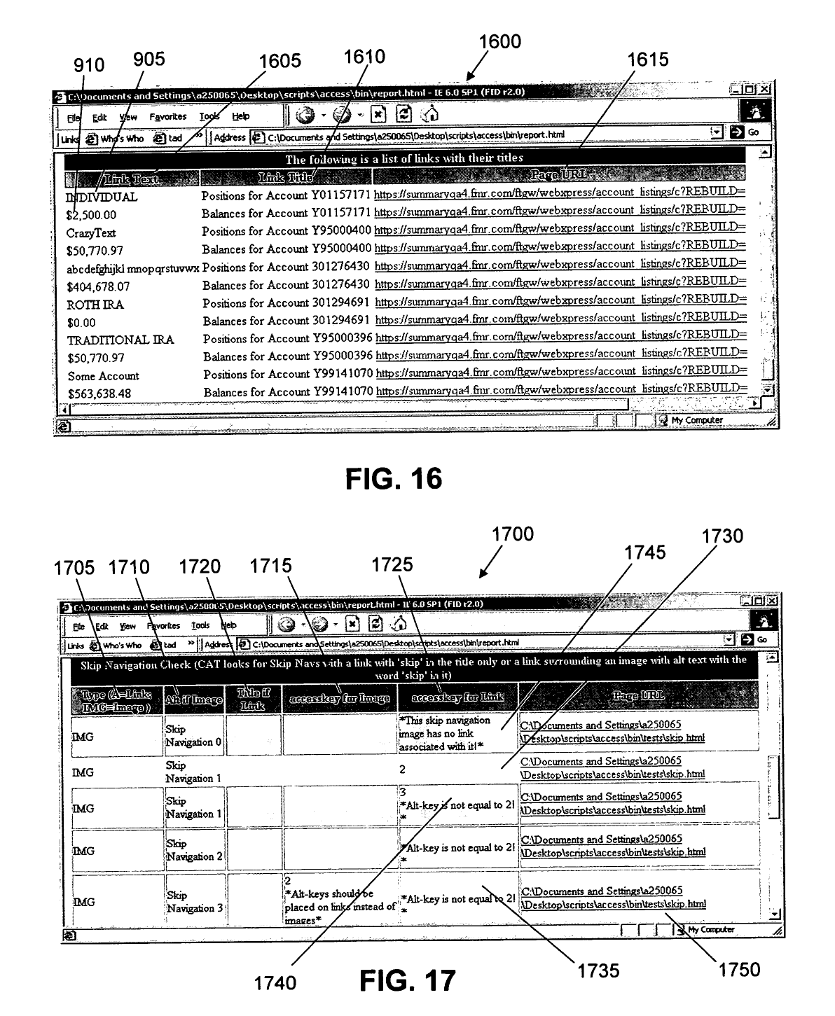

FIG. 16 is a report 1600 generated by the automated tool listing compliant link titles. The report 1600 displays the hyperlink text 1605, the title 1610 assigned to the hyperlink, and the page URL 1615 that the hyperlink is found on. In this particular report 1600, information regarding the hyperlinks 905, 910 of FIG. 9 is displayed.

FIG. 17 is a report 1700 generated by the automated tool highlighting non-compliant skip navigations. As described herein, the tool and techniques highlight two types of skip navigation: images and hyperlinks. The type 1705 of the skip navigation is listed in the leftmost column, followed by the alt-text 1710 (if the skip navigation is an image).

If the skip navigation is an image, then the accesskey 1715 is listed if it exists. Accesskeys for image skip links are typically not compliant. Accesskeys move the user to a portion of the page that may be more relevant to what the user desires to do (e.g., fill out a form). Having an accesskey defined for an image will not assist the user in navigating around the document as accesskeys are designed to do primarily because the user cannot enter information into the image. Therefore, the report generated as illustrated in FIG. 1 reports when images have accessekeys (and are therefore not typically compliant).

If the skip navigation is a hyperlink, the link title 1720 is displayed, as well as the accesskey 1725. For skip navigations with an accesskey set to “2” (e.g., cell 1730), the background of the row for that skip navigation is displayed as one color, e.g., white or light blue. For skip navigations that do not have an accesskey defined 1735 (as shown, no number is displayed in the upper leftmost corner of the table cell), or have an accesskey 1740 that does not equal “2”, e.g., is “3”, the preferred background of the row for that skip navigation is a pink color. Additionally if the skip navigation is an image and has no hyperlink associated with the image, the automated tool displays a message 1745 indicating that the skip navigation image does not have an associated hyperlink. Regardless if the skip navigation type is an image or a hyperlink, the page URL 1750 where each skip navigation link is located is presented.

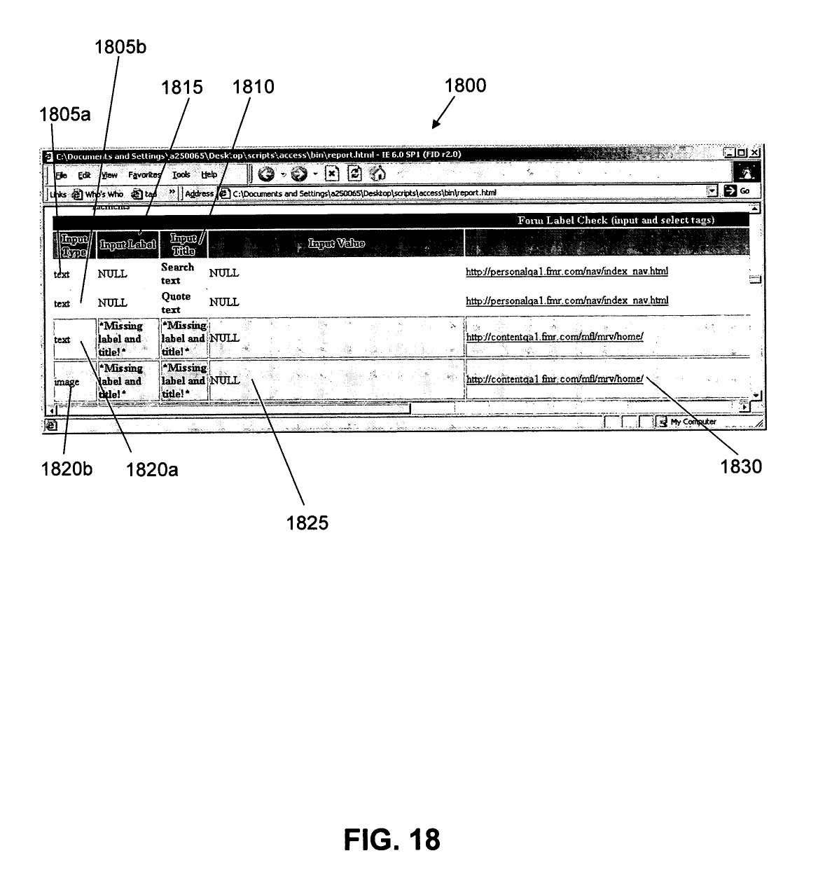

FIG. 18 is a report 1800 generated by the automated tool highlighting non-compliant form elements. The report 1800 lists the compliant and non-compliant form elements of the site or section. For example, inputs of type text 1805a, 1805b (generally 1805) that have a title 1810 defined are compliant despite lacking a label 1815. Text inputs 1820a, 1820b (generally 1820) that are missing both title 1810 and label 1815 are deemed not compliant. The report 1800 typically changes the color of the background of the listing for the non-compliant elements 1820 to a color, preferably pink, that is different than the color of the background of the document or the compliant elements 1805. In addition to input types 1805, 1820, titles 1810, and labels 1815, default input values 1825 are also displayed (if assigned), as well as the page URL 1830 of the page that the form element is found on.

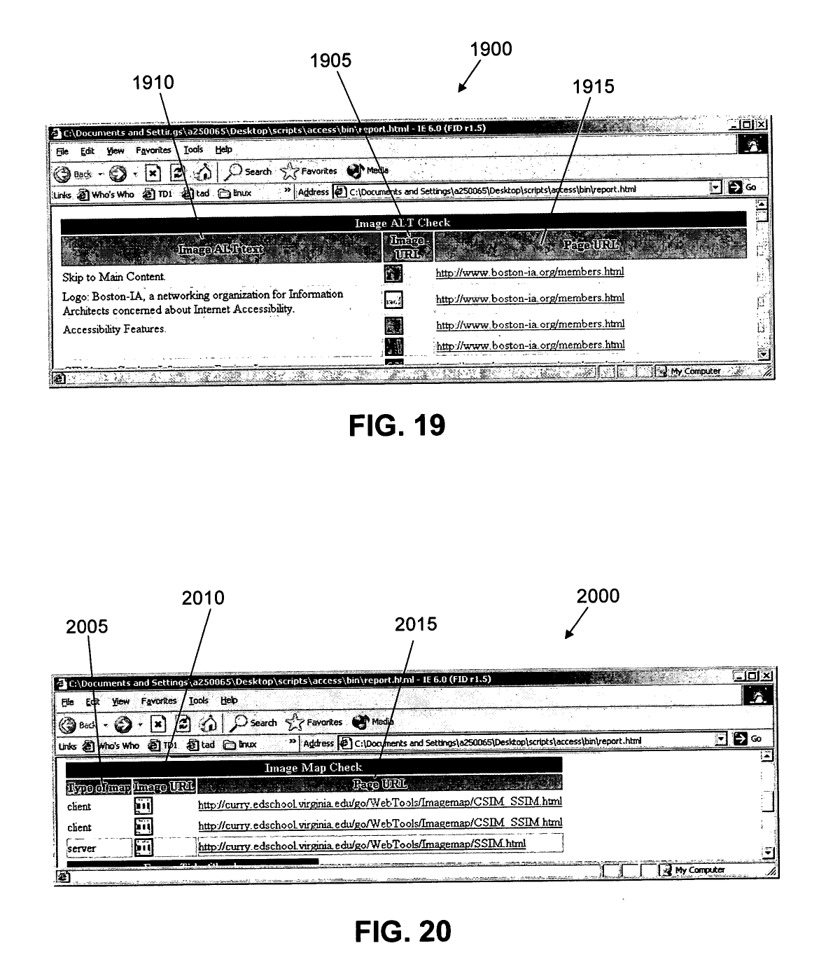

FIG. 19 is a report 1900 generated by the automated tool highlighting images found within the site. The report 1900 displays small, preview renderings, i.e., “thumbnails” 1905, of images on the site. The report 1900 also lists the alt-text 1910 associated with each image. Using the thumbnail 1905 and the alt-text 1910, the compliance tester and/or site developer can generally determine if the alt-text 1910 is useful or applicable to that particular image. In addition to the thumbnail 1905 and the alt-text 1910 display, the page URL 1915 where the image is located is also displayed.

FIG. 20 is a report 2000 generated by the automated tool highlighting non-compliant image maps. As described herein, use of server-side image maps 405, is typically non-compliant. As such, it is beneficial to have the report 2000 of all image maps present on a website to quickly determine if server-side image maps 405 are used (as well as if client-side image maps are). In FIG. 20, the type 2005 of the image map is displayed. An image thumbnail 2010, similar to that described in reference to FIG. 19, is also displayed, previewing what the image map looks like. The page URL 2015 where the map is found is also displayed. Server-side image maps 405 in particular have the background of their listing changed to a color, preferably pink, that is a different color than that of the report 2000 background or of the color used, e.g., white or light blue, for compliant, client-side image maps.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

Though embodiments described herein use web pages as an exemplary embodiment, other document types and formats are contemplated. For Portable Data Format (PDF) documents, Adobe Systems, Inc.'s Acrobat Reader may be used. For Microsoft Word Documents, Microsoft Word or MS Word-compliant programs such as Star Office by Sun Microsystems may be used to view the generated document. Rendering platforms not described, however, do not limit the scope of the invention as it is not tied to any one particular document-oriented implementation technology.

The figures above display, but do not limit, the various implementations of the aspects of the invention that illustrate non-compliant elements in a document, in particular, a web page.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A computerized method for verifying document compliance to a subsidiary standard, the method comprising:
obtaining a set of rules representing one or more requirements of the subsidiary standard;
determining, using a first rule from the set of rules, if an element of the document is compliant with the subsidiary standard; and
generating a display of the document in a browser application, showing the element as normally displayed if the element is compliant or showing the element displayed with a visual indicator if the element is not compliant.

2. The method of claim 1, wherein the subsidiary standard comprises an accessibility standard.

3. The method of claim 2, wherein the accessibility standard comprises United States Section 508, United Kingdom Disability Discrimination Act, Canadian Common Look and Feel, eEurope Plan, guidelines established by a corporate policy, or Web Content Accessibility Guidelines.

4. The method of claim 1, further comprising if the element is compliant, displaying a visual indicator indicating the compliance.

5. The method of claim 4 wherein the indicator indicating compliance is displayed in a color different than that used to visually indicate non-compliance.

6. The method of claim 1, further comprising displaying an explanation of the non-compliance when a cursor or mouse pointer is moved over the element or visual indicator.

7. The method of claim 1, wherein the document is a first web page.

8. The method of claim 7, further comprising executing cross-frame JavaScript included with the first web page.

9. The method of claim 7, further comprising navigating to a second web page.

10. The method of claim 9, wherein navigating comprises navigating to a second web page in response to a user selecting a hyperlink on the first web page.

11. The method of claim 7, wherein determining comprises verifying a skip navigation element exists.

12. The method of claim 11, wherein determining further comprises verifying the skip navigation element is assigned an accesskey value.

13. The method of claim 7, wherein determining comprises comparing an assigned alt-text value for the element with a preferred alt-text value for the element.

14. The method of claim 1, wherein the element is a form element.

15. The method of claim 1, wherein the element is a table element.

16. A computerized method for verifying web page compliance to an accessibility standard, the method comprising:
obtaining a web page;
determining if an element of the web page is compliant with the accessibility standard; and
displaying the web page using a browser application, showing the element as normally displayed if the element is compliant with the accessibility standard or showing the element displayed with a visual indicator if the element is not compliant.

17. The method of claim 16, wherein the accessibility standard comprises United States Section 508, United Kingdom Disability Discrimination Act, Canadian Common Look and Feel, eEurope Plan, or Web Content Accessibility Guidelines.

18. The method of claim 16, wherein the accessibility standard comprises guidelines established by a corporate policy.

19. A computer program product, tangibly embodied in an information carrier, for verifying compliance of a web page to a subsidiary standard, the computer program product including instructions being operable to cause a data processing apparatus to:
obtain the web page;
determine if an element of the web page is compliant with the subsidiary standard; and
display the web page using a browser application, showing the element as normally displayed if the element is compliant with the subsidiary standard or showing the element displayed with a visual indicator if the element is not compliant.

20. The computer program product of claim 19, wherein the subsidiary standard comprises United States Section 508, United Kingdom Disability Discrimination Act, Canadian Common Look and Feel, eEurope Plan, guidelines established by a corporate policy, or Web Content Accessibility Guidelines.

21. A system for verifying compliance of a web page to a subsidiary standard, the system comprising:
a computer system;
a browser software residing in a memory of the computer system;
a compliance software residing in the memory of the computer system, the compliance software configured to:
obtain the web page;
determine if an element of the web page is compliant with the subsidiary standard; and
display the web page using the browser software, showing the element as normally displayed if the element is compliant with the subsidiary standard or showing the element displayed with a visual indicator if the element is not compliant.

22. The system of claim 21, wherein the subsidiary standard comprises United States Section 508, United Kingdom Disability Discrimination Act, Canadian Common Look and Feel, eEurope Plan, guidelines established by a corporate policy, or Web Content Accessibility Guidelines.
